(19) United States
(12) Patent Application Publication
(10) Pub. No.: US 2022/0227366 A1
(43) Pub. Date: Jul. 21, 2022

(54) VEHICULAR SENSING SYSTEM WITH UPPER AND LOWER SENSORS AND WITH RECONFIGURABLE ALERT TRIGGERS

(71) Applicant: Magna Electronics Inc., Auburn Hills, MI (US)

(72) Inventor: Nishant K. Shah, Auburn Hills, MI (US)

(21) Appl. No.: 17/648,182

(22) Filed: Jan. 18, 2022

Related U.S. Application Data
(60) Provisional application No. 63/199,705, filed on Jan. 19, 2021.

(51) Int. Cl. B60W 30/095; B60W 30/18

(52) U.S. Cl. CPC B60W 30/095; B60W 2420/42; B60W 2554/4049; B60W 30/18036

(57) ABSTRACT

A vehicular backup assist system includes an upper sensor disposed at a rear upper portion of a vehicle and sensing rearward of the vehicle at a height relative to ground of the rear upper portion of the vehicle, and a lower sensor disposed at a rear lower portion of the vehicle and sensing rearward of the vehicle at a height of the rear lower portion of the vehicle. The system, during a reversing maneuver of the vehicle, and via processing at an electronic control unit of sensor data captured by the upper and lower sensors, detects presence of objects rearward of the vehicle. During the reversing maneuver, the system, via processing of sensor data captured by the upper sensor, detects presence of an object at the height of the rear upper portion of the vehicle and alerts a driver of the vehicle of the detection of the object.

### CROSS REFERENCE TO RELATED APPLICATION

The present application claims the filing benefits of U.S. provisional application Ser. No. 63/199,705, filed Jan. 19, 2021, which is hereby incorporated herein by reference in its entirety.

### FIELD OF THE INVENTION

The present invention relates generally to a vehicle sensing system for a vehicle and, more particularly, to a vehicle sensing system that utilizes one or more ultrasonic sensors at a vehicle.

### BACKGROUND OF THE INVENTION

Use of sensors in vehicle sensing systems is common and known. Such sensors are integrated at the vehicle and may sense areas rearward of the vehicle to assist the driver in reversing the vehicle.

### SUMMARY OF THE INVENTION

A driver assistance system or vehicle sensing system or rear backup assist system for a vehicle utilizes one or more sensors to capture sensor data representative of the presence of objects exterior of the vehicle. The system includes one or more sensors (preferably one or more ultrasonic sensors) disposed at an upper rear portion of the vehicle. The system also includes an electronic control unit (ECU) with a processor for processing sensor data captured by the one or more sensor. The system, such as responsive to processing at the ECU of sensor data captured by the one or more sensors, detects the presence of an object in the vicinity of the vehicle and notifies or alerts a driver of the vehicle of the detection.

The system may, responsive to detecting presence of the object, determine a horizontal distance of the object from the vehicle and a vertical distance of the object from the vehicle. The horizontal distance is determined on a horizontal plane and in a rearward direction from the vehicle and the vertical distance is determined on a vertical plane and in an upward direction from the ground or vehicle.

The system may notify or alert the driver of the vehicle of the detection of an object when the horizontal or vertical distance of the detected object from the vehicle is less than one or more threshold distances. The one or more threshold distances may be adjusted between a respective minimum value and a respective maximum value, such as via user input, to provide a notification or alert to the driver of the vehicle of the detection of an object at a distance further from the vehicle than a preset value of the one or more preset threshold distances.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a sensing system that incorporates sensors;

FIG. 2 is an environmental view of a vehicle with a sensing system that incorporates sensors; and

FIG. 3 is another environmental view of the vehicle of FIG. 2.

### DESCRIPTION OF THE PREFERRED EMBODIMENTS

A vehicle sensing system and/or driver assist system and/or object detection system and/or ultrasonic or sonar system and/or alert system operates to capture sensing data and/or image data exterior of the vehicle and may process the captured data to display images and detect objects at or near the vehicle and in the predicted path of the vehicle, such as to assist a driver of the vehicle in maneuvering the vehicle in a forward or rearward direction. The system includes a processor that is operable to receive sensing data and/or image data from one or more sensors/cameras and provide an output, such as a warning indication and/or display output to a display device for displaying images representative of the captured image data. Optionally, the system may provide display, such as a rearview display or a top down or bird's eye or surround view display or the like.

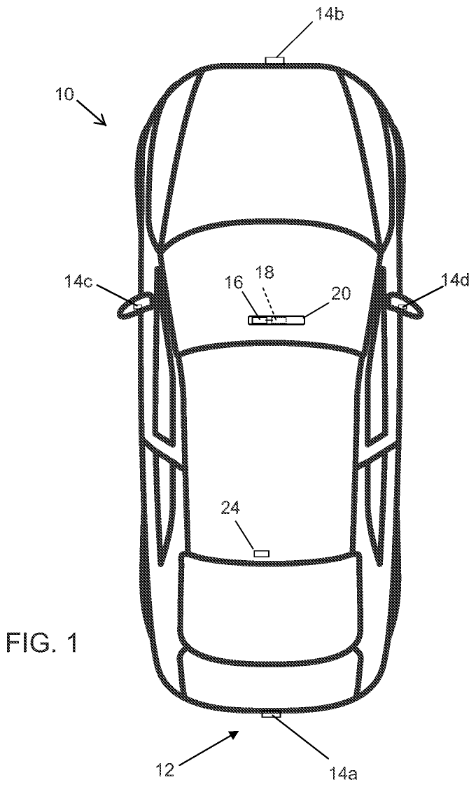

Referring now to the drawings and the illustrative embodiments depicted therein, a vehicle 10 includes an object detection system or driver assistance system or sensing system 12 that includes at least one ultrasonic sensor units, such as a rearward facing sensor 14 and a roof-line sensor unit 24 (which may comprise one or more rearward sensing sensors, such as two or more sensors, such as, for example, four sensors) at the roof or upper rear portion of the vehicle (FIG. 1). The system 12 may optionally include multiple exterior facing sensors, such as cameras or other sensors, such as a rearward sensing ground sensor 14a at a lower rear portion or bumper of the vehicle 10, a forward sensing sensor 14b at the front of the vehicle 10 (and optionally a forward facing sensor or camera at the windshield of the vehicle), and sideward/rearward sensing sensors 14c, 14d at respective sides of the vehicle), which sense regions exterior of the vehicle 10. The sensing system 12 includes a control or electronic control unit (ECU) 18 having electronic circuitry and associated software, with the electronic circuitry including a data processor and/or image processor that is operable to process sensor and/or image data captured by the sensor units and/or cameras, whereby the ECU 18 may process the sensor and/or image data to detect or determine presence and/or proximity of objects or the like. The system 12 may provide displayed images at a display device 16 for viewing by the driver of the vehicle (although shown in FIG. 1 as being part of or incorporated in or at an interior rearview mirror assembly 20 of the vehicle, the control 18 and/or the display device 16 may be disposed elsewhere at or in the vehicle). The data transfer or signal communication from the camera to the ECU may comprise any suitable data or communication link, such as a vehicle network bus or the like of the equipped vehicle.

Many driving assistance and parking assistance systems include ultrasonic sensors at the bumpers of vehicles. The sensors are able to detect the presence of obstacles when the sensor (and therefore, the bumper) is within a threshold distance of the obstacles. However, current systems typically provide object detection distance or proximity information relative to the host vehicle only at the ground level, or in other words in a single axis direction relative to the location of the sensor on the vehicle. Yet, it is also important to detect objects and provide proximity information relative to a roof-line or side profile such as near sliding doors of a vehicle, or in other words in a second and/or third axis direction. It has been observed that many drivers, when engaging in a reverse maneuver of a vehicle, pay attention mainly to potential objects in the path of the vehicle at or near ground-level, such that the driver is not aware of potential hazards threatening impact at other regions of the vehicle, such as at or near the roof of the vehicle (such as low garage openings, hanging tree branches, etc.) or at or near the sides of the vehicle. Also, a driver or occupant of a vehicle may activate an automatic sliding door function of the vehicle without noticing or checking to see an object in the travel path of the sliding door, resulting in an impact between the door and object. These scenarios may lead to damage of the vehicle such as at the roof and/or sliding doors or to damage of a garage or covered parking roof or damage to other undetected objects in the path of the vehicle, which may require expensive repairs for the car, garage and/or undetected object. These problems are most commonly observed in box trucks, cargo vans, passenger vans, SUVs, and other tall or large vehicles and/or vehicles with sliding doors.

The vehicle sensing system 12 includes one or more sensors (such as ultrasonic sensors or the like) at or near the roof of the vehicle that sense objects in the path of the vehicle at or near the roof of the vehicle. Additionally, signals from these one or more sensors may be used to calculate or estimate or determine (at the ECU) the distance and height of the detected object from the roof-line of the vehicle, where the roof-line may be a horizontal plane at the highest point of the vehicle from the ground surface. The system 12 may determine distance to an object in separate and discernible vertical and horizontal directions, where the vertical direction is upward from the roof-line of the vehicle and the horizontal direction is along a midline of the vehicle directly rear or forward of the vehicle.

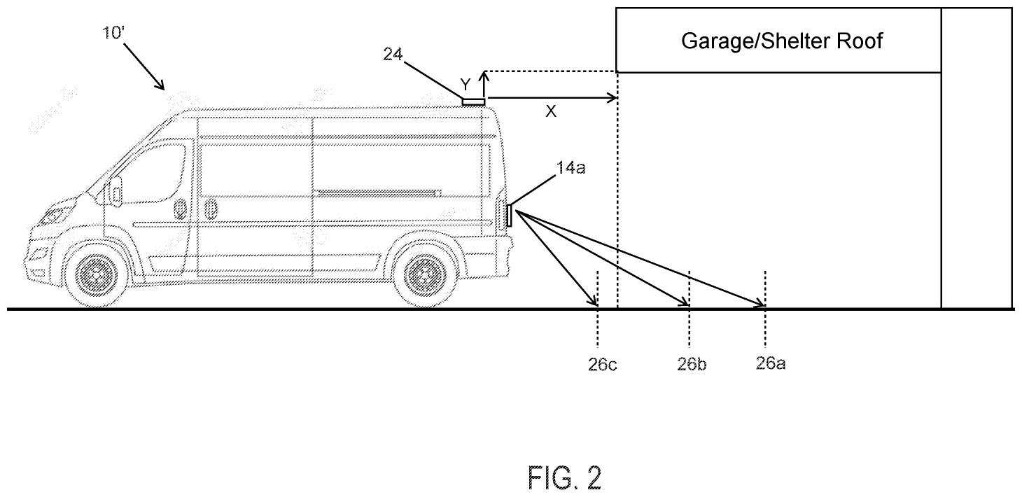

The system 12 may determine distance relative to a given or configured point at the vehicle (which may be referred to as an origin point). In the implementation of rear-facing roof-line sensors, the origin point (as shown in FIG. 2) may be configured at a point representing the rear-most point of the roof of the vehicle at a height representing the highest point of the vehicle's roof along a midline of the vehicle. The origin point may not represent a physical point at the roof of the vehicle, but rather a configured reference point above the roof of the vehicle so as to account for a curve or other feature of the roof where the highest point of the roof does not correspond to the rear-most point of the roof or to provide a buffer between the origin point and actual highest point of the roof of the vehicle.

The sensors 24 at or near the roof of the vehicle communicate captured sensor data to an ECU of the system. Responsive to processing of sensor data, the system detects presence of an object rearward of the vehicle and in the vicinity of the vehicle and determines a horizontal distance of the object from the vehicle and a vertical distance of the object from the vehicle. The horizontal distance X is determined on a horizontal plane in a rearward direction from the vehicle. The vertical distance Y is determined on a vertical plane in an upward direction from the vehicle. Responsive to determining the horizontal distance and vertical distance of the detected object from the vehicle (or configured origin point), the system transmits a signal to the driver of the vehicle. The signal may be a light or audio alert or message at an indicator light or video display or speaker of the vehicle, where the signal is relevant to the determined horizontal and/or vertical distance of the object from the vehicle. The system may also compare the determined horizontal and vertical distances to respective horizontal and vertical threshold distances and an alert or signal may only be displayed to the driver if the horizontal or vertical distance to the detected object is less than the respective threshold distance. The system may have multiple horizontal and/or vertical threshold distances corresponding to different alert signals and may have different threshold distance values for the vertical and horizontal distances. As described further below, the system may also allow for custom or configurable threshold distances.

The system 12 may selectively communicate a signal to the driver of the vehicle based on the threshold distance or value so that the driver only receives an alert when an object presents a hazard or to reduce the frequency of alerts. The system may also allow a user to customize or configure the already preset threshold distance or distances at which the driver receives a sensor warning or alert per the user's convenience (such as based on a garage location or desired buffer zone) by adjusting the existing threshold values for signaling warnings/alerts (for example, increasing the threshold values to increase safety or further prevent damage to the vehicle or surroundings). This means a user can configure the horizontal and/or vertical threshold distances in such a way to add extra padding distance to any and all warning indicator levels so that user can hear or see a warning when an object is detected at a further distance than they would if using the original preset threshold values and thus can stop the car earlier or at a further distance from a detected object. Also, the user may only alter the threshold values to be greater than minimum threshold values, such as the preset threshold values, so as to avoid violating any NHTSA or other governmental mandates for such backup sensor systems (i.e., the user cannot adjust the threshold values to less than the factory preset settings or in a way that would violate mandated requirements).

The alert or warning may change depending on the distance to the object. For example, an audible tone may increase in frequency or intensity the closer the object is to the roof. That is, as the vehicle reverses toward the object, the system may indicate a relative or absolute distance between the roof and the detected object to the driver of the vehicle. The alert may be relative to a preset threshold distance, such that an alert or signal or message is triggered upon a determination by the system that the vehicle's distance to a detected object in either the horizontal or vertical direction is less than a preset threshold amount. The alert also may be directly related to the determined horizontal or vertical distance of the vehicle to the detected object, such that the output is the measured horizontal or vertical distance of the vehicle to the detected object, or may otherwise be dependent upon or include the measured horizontal or vertical distance of the vehicle to the detected object (such as an image at the display including the measured distances).

Referring now to FIG. 2, a vehicle 10′ has the roof-line sensor unit 24 on or at the roof at a rear portion of the vehicle 10′. The one or more sensors of the roof-line sensor unit 24 detects the presence of objects in a rearward and upward direction at or near the roof of the vehicle 10′. The vehicle 10′ also has a ground-level sensor 14a at a lower rear portion of the vehicle, such as at a rear bumper or rear tailgate of the vehicle, for detecting objects in the rearward path of travel of the vehicle at or near ground-level. As shown, the roof-line sensor unit 24 captures sensor data representative of the presence of the garage/shelter roof and the system, and, based on processing of the captured sensor data, determines a horizontal distance X and a vertical distance Y from the origin point of the vehicle 10′ to the nearest detected point of the object.

The system 12 may be configured with three different horizontal threshold distances 26a, 26b, 26c and provide alerts if the ground-level sensor 14a detects the horizontal distance from the vehicle of an object is less than one of the three horizontal threshold distances 26a, 26b, 26c, where the alert changes based on the nearest threshold distance that the object has breached. The system 12 may issue alerts regarding objects detected by the roof-line sensor 24 at the same threshold horizontal distances (from the roof-line sensor or origin point) as the ground-level sensor 14a or threshold distances specific to the roof-line sensor 24. In other words, the system may differentiate between objects detected by the roof-line sensor and the ground level-sensor and the distances of the objects relative to different sensors. The ground-level sensor or sensors may function separately and independently from the roof-line sensor or sensors or cooperate with the roof-line sensor to increase the total sensing field of the system. For example, based on the field of sensing of the ground-level sensor 14a and the field of sensing of the roof-line sensor unit 24, the system may have a total field of sensing rearward of the vehicle that includes the entire height of the vehicle between the ground level and the roof-line.

During a reversing maneuver of the vehicle, and responsive to processing of sensor data captured by the sensor 24, the system 12, such as via processing of an output of the sensors at the ECU, detects presence of an object rearward of the vehicle and in the vicinity of the vehicle, and the system 12, responsive to detecting presence of the object, alerts a driver of the vehicle of the detection of the presence of the object. The system 12 determines the vertical and horizontal distance of the detected object relative to the vehicle as the vehicle approaches the object while reversing. Thus, the system 12 determines the distance of a detected object in both vertical and horizontal directions (X and Y axes) and may output the determined distances (or an alert relative to the determined distance) as a signal or message to a driver of the vehicle. Optionally, the system 12 may determine the horizontal distance of an object from the vehicle in a third direction (Z axis) perpendicular to the X axis (i.e., sideways from the vehicle). The system may determine the distance of the object in the third direction relative to a center or mid-line of the vehicle, relative to a side of the vehicle, or relative to a travel path of a door of the vehicle when the door is opened and closed. Thus, for example, the system may determine the horizontal position of the object relative to the mid-line of the vehicle for a user to determine how to maneuver around the object and the system may determine whether an object at the side of the vehicle is within a swing or travel path of a door of the vehicle (e.g., a pivoting door or a sliding door).

The system 12 may provide outputs to a driver of the vehicle in relation to the distances and/or height of a detected object relative to the vehicle. If the system 12 determines that the height of the object (or the lowest point of the object in the vicinity of the roof of the vehicle) is higher than the roof-line (or above a threshold height for alerts) of the vehicle, the system 12 may determine that no alert is necessary in relation to the object approaching the roof-line of the vehicle. If the system 12 determines that the height of the object is lower than the height of the roof-line of the vehicle (or below a threshold height for alerts) of the vehicle, the system 12 may determine that an alert is necessary in relation to the object approaching the roof-line of the vehicle. Likewise, the system 12 may communicate an alert or signal or display in relation to a detected object being closer to the vehicle in a horizontal direction than a threshold horizontal distance.

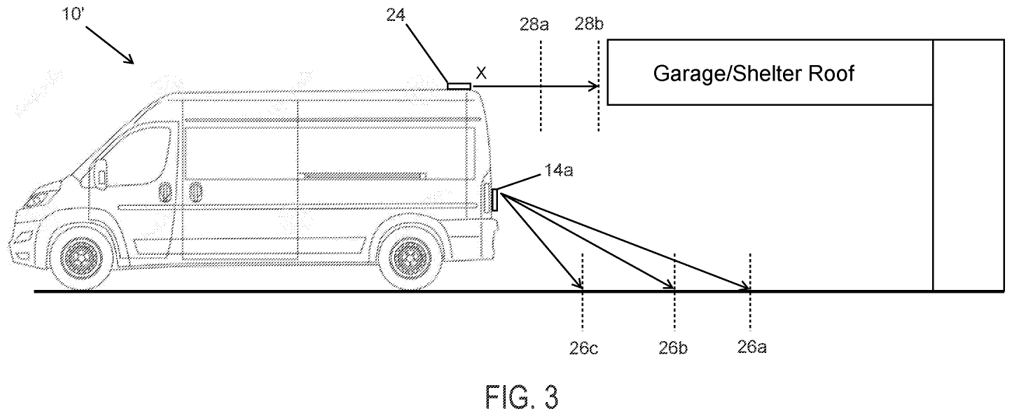

If the system 12 operates with one or more preset threshold distances for providing alerts or signals or messages to the driver of the vehicle (as opposed to just communicating an alert upon any detection of an object), the system 12 may have different preset threshold distances corresponding to different types or levels of messages or alerts. For example, and as shown in FIGS. 2 and 3, the system 12 may have low, medium, and high-level alerts corresponding to three different horizontal distances 26a, 26b, and 26c (such as 75 inches for the low-level, 45 inches for medium-level, and 15-inches for high-level) and three different alerts (such as alert sounds or indicator lights of green for low-level, orange for medium-level, and red for high-level). The system 12 may have different threshold distances and different alerts for detected objects within separate ranges of vertical and horizontal distances. The system 12 may also have different threshold distances for objects detected at the roof-line sensor and objects detected at the ground-level sensor.

Referring now to FIG. 3, the system 12 may also allow a user to configure custom threshold distances for triggering alerts by adjusting the preset threshold values (e.g., extending the distance from the vehicle at which an alert or signal or warning is communicated to the driver of the vehicle). When the system 12 includes multiple threshold values to trigger multiple alerts or signals at different distances from the vehicle, each threshold value may be adjusted (from a preset or baseline value or distance) via a user actuatable input or human machine interface (HMI) in the vehicle (such as a touch screen input or the like in the vehicle). A user may increase the distance of a detected object at which an alert is triggered from the original preset threshold distance up to a maximum threshold distance based on the capability of the sensor or sensors of the system. The threshold distance may not be decreased by the user below a minimum value, such as the original preset value, so as to maintain the system's compliance with NHTSA and/or other governmental mandates.

For example, in the illustrated embodiment, the system 12 is shown having a preset horizontal threshold distance 28a for triggering an alert to the driver of the vehicle 10′ if an object detected by the roof-line sensor 24 is closer to the vehicle 10′ than the threshold distance 28a. Because the distance 28a represents the minimum threshold distance, a user may not reduce the distance from the vehicle at which an alert is triggered below that value. However, as depicted, the preset threshold distance 28a may be increased, such as to distance 28b, so as to initiate a signal to the driver at that further distance 28b. A user may provide an input for adjusting the threshold value or values in any suitable manner, such as via human machine interface (HMI) within the vehicle such as an actuatable switch or button on the dashboard of the vehicle or via input on a separate device in communication with the system, such as, for example, via an app on the user's mobile phone.

Optionally, the user may adjust the threshold distance for alerts for objects detected at the ground level (as sensed by the sensor 14) independent from the threshold distance for alerts for objects detected at the roof level (as sensed by the sensor 24), depending on the user's preferences and not below a minimum threshold level. For example, the user may increase the threshold distance for alerts for objects detected by the sensor 24, while not adjusting the threshold distance for alerts for objects detected by the sensor 14.

The reverse sensing system may also be utilized in conjunction with a rear-viewing imaging system or backup camera of the vehicle. Typically, rear-viewing cameras that provide video images to the driver of the vehicle primarily show the ground area directly behind the vehicle so that the driver may see and avoid objects and the like that may be in the path of the vehicle as the vehicle reverses. Implementing the reverse sensing system of the present invention with such a rear-viewing imaging system would allow the driver to also be made aware of potential hazards at or near the roof-line of the vehicle. For example, the system may display a warning relating to the proximity of an object at the roof-line overlaid onto the rearward images displayed at the video display screen. The system may also display the relative distance to the object or height of the object compared to the roof-line of the vehicle. For example, if an object is in the path of the vehicle at a height of 12 inches above the roof-line of the vehicle, as the driver performs a reversing maneuver of the vehicle, the imaging system may provide rearview images of the path of the vehicle and an alert that an object is in the path of the vehicle at a height of 12 inches above the vehicle and a given horizontal distance from the vehicle. As the vehicle continues its reversing maneuver and approaches the object above the vehicle, the value indicating horizontal distance shown at the display may decrease, reflecting the horizontal distance of the object from the vehicle, while the vertical distance indicator at the display remains relatively stable, reflecting that the vertical distance of the object from the roof-line has remained constant. Thus, the driver may be alerted that an object exists in the reverse path of the vehicle, but that the object is above the height of the vehicle and the driver may safely continue the reverse maneuver. Furthermore, the system may include additional cameras at the roof sensors for providing rearward images at the roof-line of the vehicle simultaneously, additionally, or alternatively to the ground images when the backup camera system is in use.

The roof-line sensors may be disposed directly in the roof of the vehicle or as part of a removable unit to be disposed at the roof. Thus, a vehicle without built-in roof-line sensors may be equipped with a roof-line sensor unit and the sensor system configured to provide enhanced and more accurate alerts based on proximity of an object to the roof of the vehicle. In these implementations, the sensors may be powered by a removable or rechargeable battery (e.g. a lithium ion battery) and may either be in communication with the ECU of the vehicle (wirelessly or wired) or comprise a built-in ECU at the roof-sensor unit, or communicate wirelessly (such as via BLUETOOTH®) with a wireless device that comprises an ECU for processing the sensor data captured at the roof-line sensor.

Thus, the present invention adds a sensor or adds a series of sensors at the roof of the vehicle to determine or provide the distance of the closest point of an object (e.g., a garage opening) from the roof of the vehicle. Such sensors will be capable of determining the height of the roof's opening from the highest point of the vehicle. In short, such sensors will be able to determine distance in the X and Y directions rearward of the vehicle. The system thus can avoid damage of the vehicle roof and/or of the garage and can thus avoid expensive repairs caused due to miscalculation of the roof of vehicle along with the garage height.

Thus, the present invention provides a sensor, such as, for example, an ultrasonic sensor, disposed at or near or integrated at the roof of a vehicle to provide improved ability to generate an alert before the roof impacts an object rearward of the vehicle during a reversing maneuver of the vehicle. The ultrasonic sensor detects the presence of objects near the roof of the vehicle and communicates this detection to an ECU. The system generates a notification or warning or alert for a driver of the vehicle, indicating the presence of the object near the roof. Optionally, the sensor at the roof may comprise a camera or other sensor that views or senses the area immediately surrounding the vehicle at the roof, with image data captured by the camera being processed for object detection.

The sensor or camera may comprise any suitable sensor or camera. Optionally, such as if the system utilizes one or more cameras, the camera may comprise a “smart camera” that includes the imaging sensor array and associated circuitry and image processing circuitry and electrical connectors and the like as part of a camera module, such as by utilizing aspects of the vision systems described in U.S. Pat. Nos. 10,099,614 and/or 10,071,687, which are hereby incorporated herein by reference in their entireties.

The system may include an image processor operable to process image data captured by the optional camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ultrasonic sensors or the like. The imaging sensor or camera may capture image data for image processing and may comprise any suitable camera or sensing device, such as, for example, a two dimensional array of a plurality of photosensor elements arranged in at least 640 columns and 480 rows (at least a 640×480 imaging array, such as a megapixel imaging array or the like), with a respective lens focusing images onto respective portions of the array. The photosensor array may comprise a plurality of photosensor elements arranged in a photosensor array having rows and columns. Preferably, the imaging array has at least 300,000 photosensor elements or pixels, more preferably at least 500,000 photosensor elements or pixels and more preferably at least 1 million photosensor elements or pixels. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

The system may utilize sensors, such as radar or lidar sensors or the like, to detect presence of and/or range to other vehicles and objects. The sensing system may utilize aspects of the systems described in U.S. Pat. Nos. 9,753,121; 9,689,967; 9,599,702; 9,575,160; 9,146,898; 9,036,026; 8,027,029; 8,013,780; 7,053,357; 7,408,627; 7,405,812; 7,379,163; 7,379,100; 7,375,803; 7,352,454; 7,340,077; 7,321,111; 7,310,431; 7,283,213; 7,212,663; 7,203,356; 7,176,438; 7,157,685; 6,919,549; 6,906,793; 6,876,775; 6,710,770; 6,690,354; 6,678,039; 6,674,895 and/or 6,587,186, and/or U.S. Publication Nos. US-2019-0339382; US-2018-0231635; US-2018-0045812; US-2018-0015875; US-2017-0356994; US-2017-0315231; US-2017-0276788; US-2017-0254873; US-2017-0222311 and/or US-2010-0245066, which are hereby incorporated herein by reference in their entireties.

Optionally, the system may include a display for displaying images captured by one or more of the imaging sensors or for displaying messages related to the determined vertical or horizontal distance to detected objects for viewing by the driver of the vehicle while the driver is normally operating the vehicle. Optionally, for example, the system may include a video display device, such as by utilizing aspects of the video display systems described in U.S. Pat. Nos. 5,530,240; 6,329,925; 7,855,755; 7,626,749; 7,581,859; 7,446,650; 7,338,177; 7,274,501; 7,255,451; 7,195,381; 7,184,190; 5,668,663; 5,724,187; 6,690,268; 7,370,983; 7,329,013; 7,308,341; 7,289,037; 7,249,860; 7,004,593; 4,546,551; 5,699,044; 4,953,305; 5,576,687; 5,632,092; 5,708,410; 5,737,226; 5,802,727; 5,878,370; 6,087,953; 6,173,501; 6,222,460; 6,513,252 and/or 6,642,851, and/or U.S. Publication Nos. US-2014-0022390; US-2012-0162427; US-2006-0050018 and/or US-2006-0061008, which are all hereby incorporated herein by reference in their entireties. Optionally, the system (utilizing a forward viewing camera and a rearward viewing camera and other cameras disposed at the vehicle with exterior fields of view) may be part of or may provide a display of a top-down view or bird's-eye view system of the vehicle or a surround view at the vehicle, such as by utilizing aspects of the vision systems described in U.S. Pat. Nos. 10,071,687; 9,900,522; 9,834,153; 9,762,880; 9,596,387; 9,264,672; 9,126,525 and/or 9,041,806, and/or U.S. Publication No. US-2015-0022664, which are hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular backup assist system, the vehicular backup assist system comprising:
an upper sensor disposed at a rear upper portion of a vehicle equipped with the vehicular backup assist system, the upper sensor sensing rearward of the vehicle at a height relative to ground of the rear upper portion of the vehicle;
a lower sensor disposed at a rear lower portion of the vehicle and sensing rearward of the vehicle at a height of the rear lower portion of the vehicle;
wherein the height relative to ground of the upper sensor disposed at the rear upper portion of the vehicle is higher than the height of the lower sensor disposed at the rear lower portion of the vehicle;
an electronic control unit (ECU) comprising electronic circuitry and associated software, wherein the electronic circuitry includes a processor for processing sensor data captured by the upper sensor and the lower sensor;
wherein the vehicular backup assist system, during a reversing maneuver of the vehicle, and via processing at the ECU of sensor data captured by the upper sensor and the lower sensor, detects presence of objects rearward of the vehicle;
wherein, during the reversing maneuver, the vehicular backup assist system, via processing at the ECU of sensor data captured by the upper sensor, detects presence of an object at the height of the rear upper portion of the vehicle; and
wherein the vehicular backup assist system, responsive to detecting presence of the object at the height of the rear upper portion of the vehicle, alerts a driver of the vehicle of the detection of the presence of the object at the height of the rear upper portion of the vehicle.

2. The vehicular backup assist system of claim 1, wherein, during the reversing maneuver, the vehicular backup assist system also detects presence of the object via processing at the ECU of sensor data captured by the lower sensor.

3. The vehicular backup assist system of claim 1, wherein the vehicular backup assist system, responsive to detecting presence of the object, determines a horizontal distance of the object from the vehicle and a vertical distance of the object from the ground, wherein the horizontal distance is determined on a horizontal plane and the vertical distance is determined on a vertical plane.

4. The vehicular backup assist system of claim 3, wherein, the vehicular backup assist system, responsive to determining the horizontal distance of the object from the vehicle and determining the vertical distance of the object from the ground, communicates a signal to the driver of the vehicle.

5. The vehicular backup assist system of claim 4, wherein the signal is a message at a display of the vehicle, the message comprising the determined horizontal distance of the object from the vehicle and the determined vertical distance of the object from the ground.

6. The vehicular backup assist system of claim 4, wherein the vehicular backup assist system communicates the signal to the driver responsive to the determined horizontal distance of the object from the vehicle being less than a threshold horizontal distance and the determined vertical distance of the object from the ground being less than a threshold vertical distance.

7. The vehicular backup assist system of claim 4, wherein the vehicular backup assist system communicates the signal to the driver responsive to (i) the determined horizontal distance of the object from the vehicle being less than a threshold horizontal distance or (ii) the determined vertical distance of the object from the ground being less than a threshold vertical distance.

8. The vehicular backup assist system of claim 7, wherein the threshold vertical distance is adjustable between a minimum value and a maximum value via a user input.

9. The vehicular backup assist system of claim 7, wherein the threshold horizontal distance is adjustable between a minimum value and a maximum value via a user input.

10. The vehicular backup assist system of claim 9, wherein the maximum value of the threshold horizontal distance is based on a sensing capability of the upper sensor or the lower sensor.

11. The vehicular backup assist system of claim 7, wherein the signal comprises a plurality of signals and the threshold horizontal distance comprises a plurality of threshold horizontal distances, and wherein each signal of the plurality of signals corresponds to a respective threshold horizontal distance of the plurality of threshold horizontal distances.

12. The vehicular backup assist system of claim 11, wherein each threshold horizontal distance of the plurality of threshold horizontal distances is adjustable between a respective minimum value and a respective maximum value via a user input.

13. The vehicular backup assist system of claim 3, wherein the horizontal distance is determined in a rearward direction from the vehicle and the vertical distance is determined in an upward direction from the ground.

14. The vehicular backup assist system of claim 3, wherein the horizontal distance is determined in a sideward direction from the vehicle.

15. The vehicular backup assist system of claim 14, wherein the horizontal distance is determined in the sideward direction relative to a centerline of the vehicle or a side of the vehicle.

16. The vehicular backup assist system of claim 1, wherein at least one selected from the group consisting of (i) the upper sensor comprises a camera and (ii) the lower sensor comprises a camera.

17. The vehicular backup assist system of claim 1, wherein the upper sensor comprises an ultrasonic sensor and the lower sensor comprises an ultrasonic sensor.

18. A vehicular backup assist system, the vehicular backup assist system comprising:
a camera disposed at a rear upper portion of a vehicle equipped with the vehicular backup assist system, the camera viewing rearward of the vehicle at a height relative to ground of the rear upper portion of the vehicle;
an ultrasonic sensor disposed at a rear lower portion of the vehicle and sensing rearward of the vehicle at a height of the rear lower portion of the vehicle;
wherein the height relative to ground of the camera disposed at the rear upper portion of the vehicle is higher than the height of the ultrasonic sensor disposed at the rear lower portion of the vehicle;
an electronic control unit (ECU) comprising electronic circuitry and associated software, wherein the electronic circuitry includes at least one data processor for processing image data captured by the camera and sensor data captured by the ultrasonic sensor;
wherein the vehicular backup assist system, during a reversing maneuver of the vehicle, and via processing at the ECU of image data captured by the camera and sensor data captured by the ultrasonic sensor, detects presence of objects rearward of the vehicle;
wherein, during the reversing maneuver, the vehicular backup assist system, via processing at the ECU of image data captured by the camera and sensor data captured by the ultrasonic sensor, detects presence of an object at the height of the rear upper portion of the vehicle; and
wherein the vehicular backup assist system, responsive to detecting presence of the object at the height of the rear upper portion of the vehicle, alerts a driver of the vehicle of the detection of the presence of the object at the height of the rear upper portion of the vehicle.

19. The vehicular backup assist system of claim 18, wherein the vehicular backup assist system, responsive to detecting presence of the object, determines a horizontal distance of the object from the vehicle and a vertical distance of the object from the ground, wherein the horizontal distance is determined on a horizontal plane and the vertical distance is determined on a vertical plane, and wherein the vehicular backup assist system, responsive to determining the horizontal distance of the object from the vehicle and determining the vertical distance of the object from the ground, communicates a signal to the driver of the vehicle, and wherein the signal comprises the determined horizontal distance of the object from the vehicle and the determined vertical distance of the object from the ground.

20. The vehicular backup assist system of claim 19, wherein the vehicular backup assist system communicates the signal to the driver responsive to (i) the determined horizontal distance of the object from the vehicle being less than a threshold horizontal distance or (ii) the determined vertical distance of the object from the ground being less than a threshold vertical distance.

21. The vehicular backup assist system of claim 20, wherein (i) the threshold horizontal distance is adjustable between a minimum value and a maximum value via a user input, and (ii) the threshold vertical distance is adjustable between a minimum value and a maximum value via the user input.

22. The vehicular backup assist system of claim 20, wherein the signal comprises a plurality of signals and the threshold horizontal distance comprises a plurality of threshold horizontal distances, and wherein each signal of the plurality of signals corresponds to a respective threshold horizontal distance of the plurality of threshold horizontal distances.

23. The vehicular backup assist system of claim 22, wherein each threshold horizontal distance of the plurality of threshold horizontal distances is adjustable between a respective minimum value and a respective maximum value via a user input.

24. The vehicular backup assist system of claim 19, wherein the horizontal distance is determined in a sideward direction from the vehicle.

25. A vehicular backup assist system, the vehicular backup assist system comprising:
a camera disposed at a rear upper portion of a vehicle equipped with the vehicular backup assist system, the camera viewing rearward of the vehicle at a height relative to ground of the rear upper portion of the vehicle;
a radar sensor disposed at a rear lower portion of the vehicle and sensing rearward of the vehicle at a height of the rear lower portion of the vehicle;
wherein the height relative to ground of the camera disposed at the rear upper portion of the vehicle is higher than the height of the radar sensor disposed at the rear lower portion of the vehicle;
an electronic control unit (ECU) comprising electronic circuitry and associated software, wherein the electronic circuitry includes at least one data processor for processing image data captured by the camera and sensor data captured by the radar sensor;
wherein the vehicular backup assist system, during a reversing maneuver of the vehicle, and via processing at the ECU of image data captured by the camera and sensor data captured by the radar sensor, detects presence of objects rearward of the vehicle;
wherein, during the reversing maneuver, the vehicular backup assist system, via processing at the ECU of image data captured by the camera and sensor data captured by the radar sensor, detects presence of an object at the height of the rear upper portion of the vehicle; and
wherein the vehicular backup assist system, responsive to detecting presence of the object at the height of the rear upper portion of the vehicle, alerts a driver of the vehicle of the detection of the presence of the object at the height of the rear upper portion of the vehicle.

26. The vehicular backup assist system of claim 25, wherein the vehicular backup assist system, responsive to detecting presence of the object, determines a horizontal distance of the object from the vehicle and a vertical distance of the object from the ground, wherein the horizontal distance is determined on a horizontal plane and the vertical distance is determined on a vertical plane, and wherein the vehicular backup assist system, responsive to (i) the determined horizontal distance of the object from the vehicle being less than a threshold horizontal distance or (ii) the determined vertical distance of the object from the ground being less than a threshold vertical distance, alerts the driver of the vehicle of the detection of the presence of the object at the height of the rear upper portion of the vehicle, and wherein (i) the threshold horizontal distance is adjustable between a minimum value and a maximum value via a user input, and (ii) the threshold vertical distance is adjustable between a minimum value and a maximum value via the user input.

27. The vehicular backup assist system of claim 26, wherein, the vehicular backup assist system, responsive to determining the horizontal distance of the object from the vehicle and determining the vertical distance of the object from the ground, communicates a signal to the driver of the vehicle, wherein the signal is a message at a display of the vehicle, the message comprising the determined horizontal distance of the object from the vehicle and the determined vertical distance of the object from the ground.

28. The vehicular backup assist system of claim 26, wherein the threshold horizontal distance comprises a plurality of threshold horizontal distances, and wherein each threshold horizontal distance of the plurality of threshold horizontal distances is adjustable between a respective minimum value and a respective maximum value via the user input.

29. The vehicular backup assist system of claim 28, wherein, the vehicular backup assist system, responsive to the determined horizontal distance of the object from the vehicle being less than one threshold horizontal distance of the plurality of threshold horizontal distances, communicates one of a plurality of signals to the driver of the vehicle, wherein each signal of the plurality of signals corresponds to a respective threshold horizontal distance of the plurality of threshold horizontal distances.
